(19) United States
(12) Patent Application Publication
(10) Pub. No.: US 2026/0350602 A1
(43) Pub. Date: Nov. 5, 2026

(54) SMART CONTRACT BEHAVIOR CLASSIFICATION

(71) Applicant: Telefonaktiebolaget LM Ericsson (publ), Stockholm (SE)

(72) Inventors: Bofeng PAN, Saskatoon (CA); Natalia STAKHANOVA, Saskatoon (CA); Zhongwen ZHU, Saint-Laurent (CA)

(73) Assignee: Telefonaktiebolaget LM Ericsson (publ), Stockholm (SE)

(21) Appl. No.: 19/112,262

(22) PCT Filed: Oct. 7, 2022
(86) PCT No.: PCT/IB2022/059597

§ 371 Date: Mar. 17, 2025

(51) Int. Cl. G06Q 20/38

(52) U.S. Cl. CPC G06Q 20/389

(57) ABSTRACT

A computer-implemented method is described. The method comprises receiving data representative of an event that occurs as a result of execution of a smart contract deployed on a blockchain. The method further comprises classifying a type of behavior (such as benign or anomalous, or a sub-type of anomalous behavior) of the smart contract with a machine learning model trained to identify the type of behavior from the data. The data to be classified may comprise static information such as bytecode of the smart contract and dynamic information such as a value associated with a feature that is indicative of the behavior of the smart contract.

### TECHNICAL FIELD

The present disclosure relates to monitoring and classifying smart contract behavior.

### BACKGROUND

With a rising popularity of blockchain technologies, their practical application in industry sectors is expanding as well. Blockchain technologies enable different parties who do not trust each other to share information through the use of a robust consensus protocol which eliminates the need for a central authority. The shared information can be as simple as the exchange of cryptocurrency or as complex as insurance purchase agreement dictated by a smart contract.

Blockchain technologies have evolved to enable execution of smart contracts in a decentralized way. A smart contract is a computer code that enables users to create their own arbitrary rules for ownership and state transition functions. The contract is written in a high level language (e.g., Ethereum blockchain uses Solidity programming language) and compiled into bytecode which is deployed to the blockchain where it is assigned a unique contract address which exists outside of a transaction scope alongside account addresses (allocated for users). The contract operates as an entity by itself which is able to pass messages between users and other contracts. In order to create a contract, a user with an account address creates a transaction to deploy the contract. The deployment transaction permanently binds the account address that deployed the contract to the deployed contract. Beyond executing the contracts, users can exchange other transactions.

For example, Ethereum blockchain transactions are divided into three categories: normal transactions (transactions from one account address to another account address), internal transactions (transactions that transfer Ether through a smart contract), and token transfer transactions (transactions that transfer tokens defined in smart contracts).

FIG. 1 is a schematic diagram illustrating an example blockchain ecosystem 100. The blockchain ecosystem 100 could be based on the Ethereum ecosystem described above or another type of blockchain ecosystem.

The blockchain ecosystem 100 comprises a distributed computing system 102. The distributed computing system 102 comprises a set of blockchain nodes 104 configured to maintain a blockchain ledger 106 (i.e., the blockchain), which may evolve over time in response to transactions submitted to the blockchain ecosystem 100. A set of blockchain records 108 are recorded on the blockchain ledger 106 where each record 108 (which could also be referred to as a block) comprises data representative of a transaction or a set of transactions. Each blockchain record 108 may be cryptographically linked to the other blockchain records 108. For example, a transaction may be submitted to the blockchain by one of a set of blockchain clients 110 connected to the distributed computing system 102 at a certain time. Upon successful verification of the submitted transaction (or a set of submitted transactions over a period of time), the blockchain record 108 is recorded on the ledger 106.

The blockchain record 108 may comprise a hash (e.g., generated by a cryptographic hash function such as Keccak-256 or another appropriate function) derived from the previously recorded blockchain record 108. The blockchain record 108 may further comprise data such as a cryptocurrency balance, a hash of an opcode associated with the executed smart contract, a nonce, a timestamp, etc. Since each blockchain record 108 comprises a hash derived from the previous blockchain record 108, each blockchain record 108 is cryptographically linked together. Further, each blockchain record 108 may comprise a Merkle tree root hash derived from a set of hashes derived from the transactions recorded in the blockchain record 108. In the event of a discrepancy of the Merkle tree root hash between different versions of the blockchain ledger 106 held by the blockchain nodes 104, this discrepancy can be detected and suitably addressed.

Attacks on blockchain platforms are mounting. Such attacks may be profit driven and leverage the fact that the identity of an adversary is hidden behind the account/transaction address. In fact, pseudo-anonymity is one of the main premises of public blockchain platforms such as Ethereum. Users may not be required to provide real names, and instead, hide their identities behind account numbers and pseudonyms. Since all affiliations of the account addresses are anonymous, detecting adversaries or malicious behavior on the blockchain is challenging.

The attacks on blockchain can be broadly divided into 1) attacks associated with the mathematical foundation of blockchain (e.g., blockchain fork), 2) attacks associated with the peer-to-peer blockchain architecture (e.g., selfish mining, the so-called 51% attack), and 3) attacks associated with the applications using blockchain technology (e.g., cryptojacking, reentrancy attack, smart contracts' code vulnerabilities, blockchain applications attacks).

To manage the security concerns, a number of tools have been developed to address some of these problems.

The attacks stemming from code vulnerabilities may be mitigated through static and dynamic code analysis that can verify the security properties of contracts. The dynamic analysis-based approaches require execution of a smart contract, typically through code instrumentation, to reveal runtime information (e.g., execution time, instruction count, and gas consumption). Compared to static analysis, dynamic analysis has been less widely adopted for security analysis of smart contracts.

The above-discussed approaches aim to detect vulnerabilities before smart contract deployment. A number of studies were introduced to protect already deployed contracts.

Some approaches instrument code and complement the analysis with mitigation strategy for already deployed contracts. However, such approaches may only be capable of analyzing known security vulnerabilities.

Some approaches rely on detecting known and unknown vulnerabilities based on control-flow profiling. Such approaches require code instrumentation. However, such approaches may additionally rely on safe contract execution paths collected before contract deployment (e.g., from developers) and checked against during the contract execution after deployment on the chain.

Blockchain contracts are pseudo-anonymous, however, all transactions (and the corresponding smart contracts) may be readily accessible, if the blockchain is publicly available. It is therefore possible for activity of users to be potentially tracked to expose malicious behavior. Such tracking approaches may handle specific categories of malicious behavior, e.g., detection of Ponzi scheme contracts, suspicious or malicious wallets and accounts, and phishing.

### SUMMARY

Certain embodiments described herein may facilitate improved identification of malicious activity on a blockchain.

In one embodiment, a computer-implemented method is described. The method comprises receiving data representative of an event that occurs as a result of execution of a smart contract deployed on a blockchain. The method further comprises classifying a type of behavior of the smart contract with a machine learning model trained to identify the type of behavior from the data.

In another embodiment, a computer-implemented method is described. The method comprises training a machine learning model to classify a type of behavior of a smart contract deployed on a blockchain. The training is performed using a dataset comprising data representative of behavior of a training set of smart contracts. The data associated with a smart contract of the training set is annotated in the dataset with the type of behavior exhibited by the smart contract.

In another embodiment, a non-transitory machine-readable medium is described. The machine-readable medium stores instructions which, when executed by a processor, instruct the processor to implement the method of any embodiment described herein.

In another embodiment, apparatus is described. The apparatus comprises a processor and a memory. The memory stores instructions readable and executable by the processor to instruct the processor to implement the method of any embodiment described herein.

Certain embodiments of the present disclosure may provide one or more of the following technical benefits. Certain embodiments may facilitate accurate detection and classification of anomalous behavior of smart contracts. Certain embodiments may allow already deployed smart contracted to be analyzed for anomalous behavior, e.g., for expedited detection of anomalous behavior. Certain embodiments may collect additional data in the event that the classification is not sufficiently accurate, e.g., to facilitate continued monitoring of potentially anomalous behavior. Certain embodiments may adjust the detection scope of the monitoring according to the available number of events/transactions. Certain embodiments may discover novel anomalous behavior such as security threats. Certain embodiments may recognize feature patterns discovered by learning from a training dataset rather than relying on detection of well-known threats. Certain embodiments may reduce or avoid the need to modify existing blockchain infrastructure.

This summary is not an extensive overview of all contemplated embodiments and is not intended to identify key or critical aspects or features of any or all embodiments or to delineate the scope of any or all embodiments. In that sense, other aspects and features will become apparent to those ordinarily skilled in the art upon review of the following description of specific embodiments in conjunction with the accompanying figures.

### BRIEF DESCRIPTION OF THE DRAWINGS

Exemplary embodiments will be described in more detail with reference to the following figures, in which:

FIG. 1 is a schematic diagram illustrating a blockchain ecosystem.

FIG. 2 is a flowchart of a method of training a machine learning model according to some embodiments.

FIG. 3 is a flowchart of a method of classifying a type of behavior with a machine learning model according to some embodiments.

FIG. 4 is a schematic diagram illustrating training and deployment of a monitoring system according to some embodiments.

FIG. 5 is a schematic diagram illustrating data synchronization by the monitoring system of FIG. 4.

FIG. 6 is a schematic diagram illustrating a temporal view of blockchain records over different time intervals that may be monitored by the monitoring system of FIG. 4.

FIG. 7 is a schematic diagram illustrating a model training system according to some embodiments.

FIG. 8 is a flowchart of a method of training a machine learning model according to some embodiments.

FIG. 9 is a flowchart of a method of selecting features to collect from future data according to some embodiments.

FIG. 10 is a schematic diagram illustrating a system to implement a deployed machine learning model according to some embodiments.

FIG. 11 is a flowchart of a method of classifying a type of behavior with a machine learning model according to some embodiments.

FIG. 12 is a flowchart of a method of classifying a type of behavior with a machine learning model according to some embodiments.

FIGS. 13(a)-(b) are graphs of experimental data indicating binary classification accuracy for a set of time windows.

FIGS. 14(a)-(b) are graphs of experimental data indicating multi-class classification accuracy for a set of time windows.

FIG. 15 is a schematic diagram of a machine-readable medium for implementing some embodiments.

FIG. 16 is a schematic diagram of an apparatus for implementing some embodiments.

### DETAILED DESCRIPTION

The embodiments set forth below represent information to enable those skilled in the art to practice the embodiments. Upon reading the following description in light of the accompanying figures, those skilled in the art will understand the concepts of the description and will recognize applications of these concepts not particularly addressed herein. It should be understood that these concepts and applications fall within the scope of the description.

In the following description, numerous specific details are set forth. However, it is understood that embodiments may be practiced without these specific details. In other instances, well-known circuits, structures, and techniques have not been shown in detail in order not to obscure the understanding of the description. Those of ordinary skill in the art, with the included description, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

As used herein, the singular forms “a”, “an” and “the” are intended to include the plural forms as well, unless the context clearly indicates otherwise. It will be further understood that the terms “comprises,” “comprising,” “includes,” and/or “including” when used herein, specify the presence of stated features, integers, steps, operations, elements, and/or components, but do not preclude the presence or addition of one or more other features, integers, steps, operations, elements, components, and/or groups thereof.

As already discussed, identifying and profiling malicious activity on the blockchain remains a challenge.

Certain existing approaches may focus on detection of security vulnerabilities or malicious behavior before contract deployment. Such approaches may only be capable of detecting known and well understood threats.

Once a contract is deployed on the blockchain, there may be limited support if the contract is leveraged for attacks. Detection of anomalous or suspicious behavior after deployment of a contract may be impractical. For example, some approaches monitor contract execution in real-time, but require contracts to be instrumented in advance, which may not be feasible for already deployed contracts. The approaches that do not rely on instrumentation may focus on an individual threats rather than a set of threats.

Hence, there is a significant need for practical approaches that improve detection of anomalous behavior of smart contracts deployed on a blockchain.

Certain embodiments described herein may discover malicious transactions after the contracts are deployed on the chain. As used herein, the terms “chain” and “blockchain” may be used interchangeably. Certain embodiments described herein may offer an effective solution for detecting anomalous behavior even for contracts already present on the chain and potentially new contracts. Certain embodiments described herein may be capable of detecting abnormal and suspicious behavior not limited to a set of well-known threats.

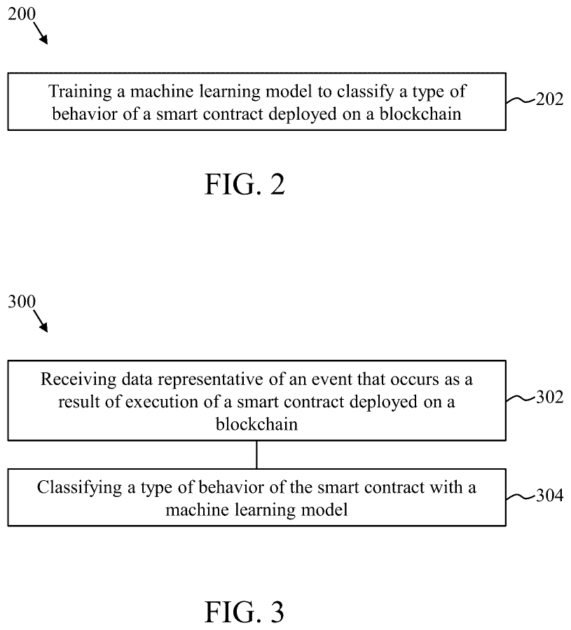

FIG. 2 is a flowchart of a method 200 of training a machine learning model according to some embodiments. In further methods described below, the trained machine learning model may be deployed in order to detect anomalous behavior of smart contracts deployed on a blockchain.

The method 200 is computer-implemented, for example, by a processor of a computing device (not shown) configured to train a model (i.e., the machine learning model) to classify a type of behavior of a smart contract. Such a model may include a Smart Contract (SC) Anomaly Footprint Detection Model (SAFDM) or an SC Footprint Classification Model (SFCM), as described below. In some cases, the computing device may be implemented by a server, cloud-based service, etc., operated or controlled by an entity tasked with training the model based on data accessible to the entity.

The method 200 comprises, at step 202, training a machine learning model to classify a type of behavior of a smart contract deployed on a blockchain. The training is performed using a dataset comprising data representative of behavior of a training set of smart contracts. The data associated with a smart contract of the training set is annotated in the dataset with the type of behavior exhibited by the smart contract.

In some cases, the type of behavior may be annotated as being anomalous or benign (normal). In some cases, the type of anomalous behavior may be further annotated in terms of a sub-type of anomalous behavior. The classification implemented by the machine learning model may be based on an appropriate classification model suitable to be used in anomaly detection. Such machine learning models may include LightGBM (Light Gradient Boosting Machine), XGboost (eXtreme Gradient Boosting), or any other appropriate model.

The dataset may comprise any data derived from a blockchain that may or may not be indicative of anomalous behavior. In some cases, such data may refer to parameter values derived from an event or set of events that occur as a result of execution of a smart contract in the training set. Some of these events may be indicative of anomalous behavior. However, such anomalous behavior may not be readily recognizable from the dataset, including in the scenario where a smart contract has already been deployed on a blockchain. A machine learning model such as described above may be capable of recognizing such behavior since it may, for example, leverage the information in the dataset spanning the data associated with multiple smart contracts in order to identify patterns in the data indicative of the anomalous behavior associated with a particular smart contract. An example of the data used in an experiment to train the model is given in the section below on system training evaluation.

As will be described in more detail herein, the trained machine learning model may provide accurate detection of suspicious transactions on the blockchain. In some cases, the characteristics of a smart contract may be extracted through a static analysis of the contract's instruction code (e.g., a static feature) and temporal attributes (e.g., a temporal feature) of the corresponding blockchain transactions (including those that executed the contracts).

In some embodiments, the data associated with each smart contract comprises a value derived from an event associated with execution of the smart contract. In some embodiments, such a value may be associated with a temporal feature. In some embodiments, such a value may be associated with a static feature.

In some cases, a temporal feature may refer to a timestamp of an event or a timing difference between events. When a smart contract is executed, a set of events may take place (for example, an event such as a transaction may be recorded on the blockchain). Each of these events may be associated with a particular time. Thus, a temporal feature may be derived from the timing of the event or the timing associated with a set of events.

In some cases, a time window within which data is to be collected may not represent a suitable amount of data (e.g., number of transactions) in order to achieve accurate detection of the type of behavior by the deployed machine learning model. Thus, the time window of the data used for classification may be adjusted by an appropriate time interval to ensure accurate classification. By way of example, the time interval could be adjusted to cover a certain time period such as in the magnitude of years, months, weeks, days, hours, minutes or seconds depending on the model training.

FIG. 3 is a flowchart of a method 300 of classifying a type of behavior with a machine learning model according to some embodiments. The machine learning model may be trained in accordance with the method 200 and related embodiments.

The method 300 is computer-implemented, for example, by a processor of a computing device (not shown) configured to use the trained machine learning model to classify a type of behavior of a smart contract. Such a model may include the SAFDM or SFCM, as described below. In some cases, the computing device may be implemented by a server, cloud-based service, etc., operated or controlled by an entity tasked with detecting anomalous behavior on the blockchain.

The method 300 comprises, at step 302, receiving data representative of an event that occurs as a result of execution of a smart contract deployed on a blockchain.

The data representative of an event may refer to any data, whether static or dynamic, that could be derived from the smart contract itself or as a result of execution of the smart contract. For example, in the case of static (or time invariant) data, the static data may comprise instruction code of the smart contract or any other information that may be static. In the case of dynamic (or time variant) data, the dynamic data may comprise data representative of a series of events (e.g., instances of certain opcodes/operands being observed at certain times).

In some cases, an event may refer to a full transaction or part of a transaction such as execution of opcode associated with the transaction.

The method 300 comprises, at step 304, classifying a type of behavior of the smart contract with the machine learning model. The machine learning model is trained to identify the type of behavior from the data.

Thus, once a smart contract is deployed on either private or public blockchain network, the classifying may be achieved by leveraging the trained model to classify anomalous transactions as described by certain embodiments.

In some embodiments, the machine learning model is trained using a dataset comprising data representative of behavior of a training set of smart contracts. The data associated with a smart contract of the training set is annotated in the dataset with the type of behavior exhibited by the smart contract. Such annotation may be indicated by a preexisting database of smart contracts known from previous analysis to be anomalous or benign.

Thus, in some embodiments, the type of behavior comprises: benign or anomalous. However, there could be further sub-types of behavior (e.g., anomalous behavior) to be classified as described below.

The deployment of the trained machine learning model to classify behavior of the smart contract may provide one or more of the following technical benefits.

In some cases, the machine learning model may be capable of expedited detection of anomalous behavior on the blockchain. Through the time-based analysis, the machine learning model may be capable of detecting anomalous behavior within a relatively short time scale (e.g., one hour, as demonstrated by experimental evidence provided below) upon transaction appearance on the blockchain. Such a short time scale may allow an admin to mitigate damage or prevent monetary or other sensitive losses in a timely manner.

In some cases, as well as identifying known security issues, the machine learning model may be capable of detecting novel security threats and anomalous although not yet malicious behavior on the chain.

In some cases, the classifying may yield the type of behavior based on already deployed smart contracts (i.e., based on the data associated with such contracts) and may require no modification of the existing blockchain infrastructure.

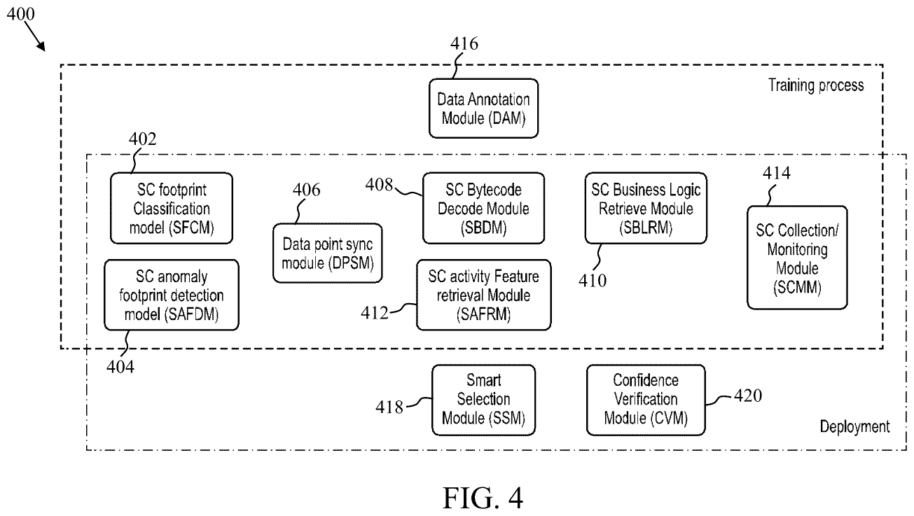

FIG. 4 is a schematic diagram illustrating training and deployment of a monitoring system 400 according to some embodiments. The monitoring system 400 comprises a set of modules, which are briefly outlined here and described in more detail below. In some cases, not all of the modules described below may be deployed as part of the monitoring system 400. Each module may be implemented by a processor of a computing system. The modules may be implemented by the same processor or they may be implemented by different processors (of the same or a different computing system). In some cases, a depicted module may comprise or have access to a memory storing instructions which, when executed by a processor, instruct the processor to implement the functionality described in relation to the module.

The monitoring system 400 comprises a set of common modules used for both machine learning model training and when the machine learning model is deployed for detection (i.e., classification) of the type of behavior. These common modules include an SC Footprint Classification Model (SFCM) module 402, SC Anomaly Footprint Detection Model (SAFDM) module 404, Data Point Synchronization Module (DPSM) 406, SC Bytecode Decode Module (SBDM) 408, SC Business Logic Retrieval Module (SBLRM) 410, SC Activity Feature Retrieval Module (SAFRM) 412, SC Collection and Monitoring Module (SCMM) 414.

The monitoring system 400 comprises a further module used for model training. This module is a Data Annotation Module (DAM) 416.

The monitoring system 400 comprises further modules used by the deployed machine learning model. These modules include a Smart Selection Module (SSM) 418 and a Confidence Verification Module (CVM) 420.

Further functionality of these modules is described in more detail below.

The SAFDM module 404 may classify the type of behavior as anomalous or benign based on a set of features derived by the SBDM 408 and SBLRM 410 (each of which are described below). The term anomalous may refer to behavior associated with a malicious entity or not caused by such an entity. For example, there may be scenarios where anomalous behavior may be caused by some other factor other than a malicious entity. The SAFDM module 404 may be trained in accordance with the method 200 and deployed in accordance with the method 300.

The SFCM module 402 may classify the type of behavior by aiming to determine the sub-type of the anomalous behavior using multi-class classification. By way of example, the sub-type may include phishing, Ponzi, crypto theft, honeypot, high risk, etc. Thus, the SFCM module 402 may provide a more granular classification than the SAFDM module 404. Thus, in some cases, the SFCM module 402 may not be needed as part of the monitoring system 400.

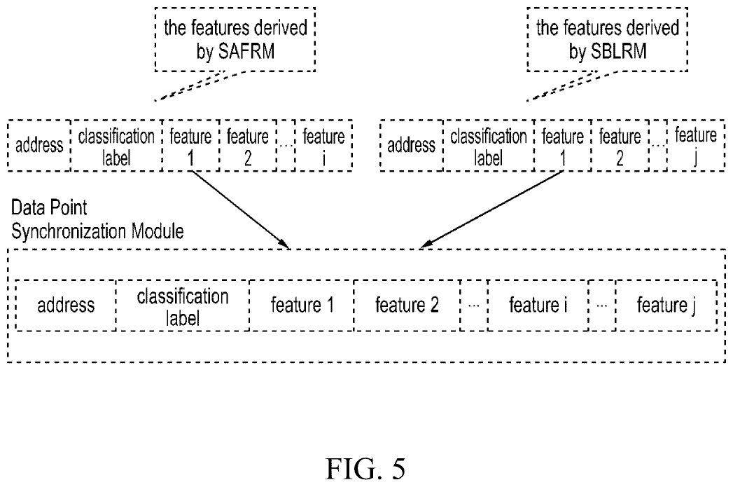

FIG. 5 is a schematic diagram illustrating data synchronization as part of the monitoring system 400 of FIG. 4. Data to be classified may come from a variety of sources. In this case, a set of values corresponding to certain features (labelled 1, 2, . . . , i) derived from the SAFRM 412 (discussed below) may be associated with an account address and a classification label (e.g., a type or sub-type of behavior). Further, a set of values corresponding to certain features (labelled 1, 2, . . . , j) derived from the SBLRM 410 (discussed below) may be associated with the account address and the classification label (e.g., a type or sub-type of behavior). The DPSM 406 may combine the extracted values corresponding to the features that characterize the smart contract's code (provided by the SBLRM 410) and transactions' behavior (provided by the SAFRM 412) for a given account address. This account address may be associated with a single user. Thus, the classifying by the SAFDM module 404 or SFCM module 402 of the smart contract's code and transactions' behavior per account may facilitate an assessment of a particular user's behavior (in case that use is attacking the blockchain platform or otherwise causing an issue with its operation even if this is not intentional).

The SBDM 408 is responsible for disassembling a retrieved contract's bytecode to opcodes and operands, which are then transferred to SBLRM 410. When a contract is deployed on the blockchain, only its bytecode is retained on the chain. To obtain the original source code of a smart contract, reverse engineering techniques can be applied on the bytecode to a limited degree. Such reverse engineering techniques may be affected by the compilation process into Ethereum Virtual Machine (EVM) bytecode. That is, optimizing the contract's bytecode for performance may change the contract's code structure while maintaining the same functionality. Human-readable variable names are not required by the EVM and are encoded. Further, the layout information of the source code is removed by the EVM. This makes the reverse engineering of the exact original source code challenging. Hence, the SBDM 408 may rely on the contract's bytecode. The contract's bytecode may be disassembled by the SBDM 408 to retrieve opcodes and operands. The resulting opcodes are used as features where such features may be form part of the data representative of an event (i.e., used as an input to the machine learning model).

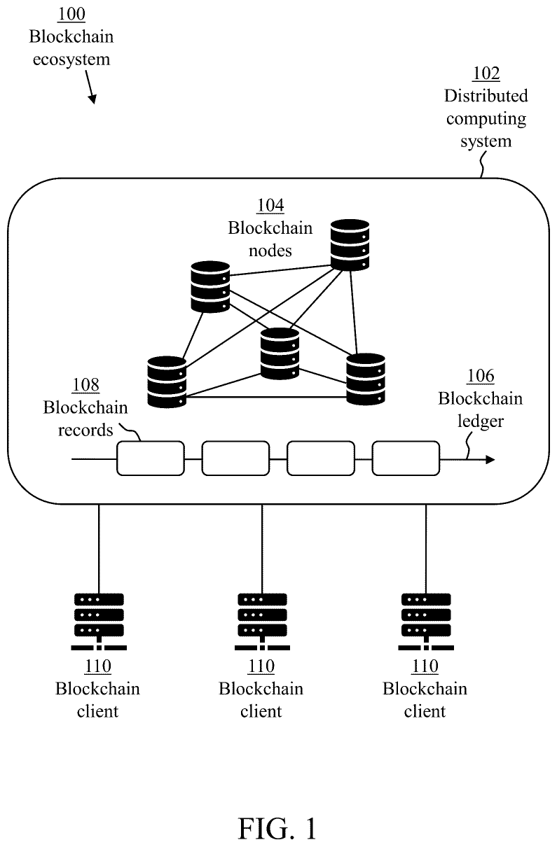

Thus, in some embodiments, the event comprises execution of instruction code for controlling an operation of a processor of a blockchain node (such as a blockchain node 104 of FIG. 1) configured to execute the smart contract. The smart contract is compiled into the instruction code. In some cases, the event may refer to execution of instruction code specified by a smart contract.

In some embodiments, the instruction code comprises bytecode. In some embodiments, the instruction code comprises opcode and operands.

In some embodiments, the data comprises content of the instruction code (e.g., opcode and operands). Such embodiments may refer to the static analysis of the bytecode. For example, if no corresponding transactions are available (e.g., unpopular contract, insufficient time after contract deployment), the detection may be only based on the code properties of the smart contract.

The SBLRM 410 may assemble features appropriate for machine learning classification. These features may characterize the smart contract's code.

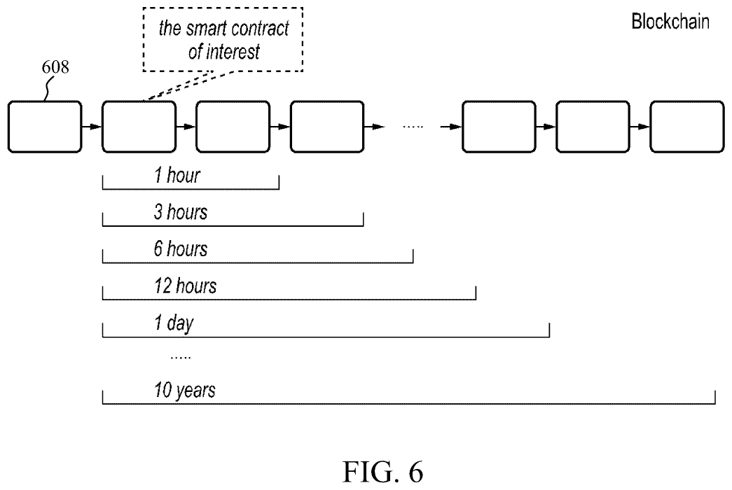

FIG. 6 is a schematic diagram illustrating a temporal view of blockchain records 608 over different time intervals that may be monitored by the monitoring system 400 of FIG. 4.

One of the blockchain records 608 may contain data representative of a smart contract of interest. Over time, this smart contract may exhibit behavior recorded in some but not all blockchain records 608. Thus, it may be useful to vary the timescale over which the data representative of the event is extracted in case the smart contract is unpopular over the initially selected timescale or if the classification is inaccurate. For example, the timescale could be extended from 1 hour to 3 hours, 6 hours, 12 hours, 1 day or even up to 10 years. As depicted by FIG. 6, increasing the timescale may allow data from more blockchain records 608 to be extracted for analysis. Varying the timescale may lead to a variation in the frequency of observed events (e.g., opcodes) over the timescale. An approach to weight such events according to their frequency may be adopted as described below.

In some cases, a TF-IDF (term frequency-inverse document frequency) measure may be used to assess the importance of retrieved document elements. For example, given an opcode i (i.e., an event) and N smart contracts, TF-IDF is a weighted measure of opcode i frequency in a smart contract sc relative to all N smart contracts available for analysis. Hence, IDFᵢ calculates how often an opcode i appears in N smart contracts, and TF_{i,sc} assess the frequency of opcode in a given smart contract.

The weighted measure of opcode i frequency in a smart contract is given by

TF-IDF=TF_{i,sc}*IDFᵢ,
where

$${IDF}_{i} = log ( 1 + \frac{N}{{f}_{i}} ) + 1 ,$$

where fᵢ is a number of smart contracts that contain at least one occurrence of this opcode i,
where

$${TF}_{i , sc} = \frac{{f}_{i , sc}}{\sum {f}_{w , sc}} ,$$

where f_{i,sc} is the frequency of opcode i in a smart contract sc, and
where Σf_{w,sc} is a total number of opcodes present in a smart contract sc.

Thus, in some embodiments, the data comprises an indication of a weighted measure of the opcode frequency in the smart contract relative to a set of smart contracts. The weighted measure may be used to specify the importance of the opcode of a smart contract, which may allow the machine learning model to asset how important a particular opcode is for classifying purposes.

The SAFRM 412 may pull the transactions and contracts for a given period of time from a storage of such data. Such a design decouples the model training process from fetching the data from a blockchain. The SAFRM 412 may parse the retrieved information and extract temporal features from the corresponding blockchain transactions. Such temporal features may characterize the type of behavior of the events (e.g., the transactions).

The SAFRM 412 derives features from the transactions' history. A list of example features that can be extracted is given in Table 1. As opposed to one approach that takes a single snapshot of transactional behavior, certain embodiments described herein may take a temporal view of events over time. The time granularity level can be adjusted based on the application domain as described in relation to FIG. 6. By way of example, the SAFRM 412 may extract features for the following time granularity windows: per hour, per 3 hours, per 6 hours, per 12 hours, per 1 day, per 3 days, per 7 days, per 14 days, per 30 days, per 90 days, per 180 days, per 365 days, 3 years, 5 years, 10 years, etc. Hence, the SBLRM 410 may generate the features such as those listed in Table 1 for each of the time windows that might be retrieved for analysis. Some of the features in Table 1 are relevant to the Ethereum ecosystem; however similar features may be extracted from other blockchain ecosystems.

TABLE 1
Features

The average time between incoming transactions (where such transactions are from the point
of view of a particular account within a considered time period)
The average time between outcoming transactions (where such transactions are from the
point of view of a particular account within a considered time period)
Time since the first until the last transaction
The longest interval between two transactions
The total number of transactions
The total number of incoming transactions
The total number of outcoming transactions
The number of unique outcoming addresses (where such addresses are associated with a
receiver of a transaction)
The number of unique incoming addresses (where such addresses are associated with a
sender of a transaction)
The proportion of unique outcoming address (out of all outcoming addresses)
The proportion of unique incoming address (out of all incoming addresses)
The proportion of outcoming transactions out of all transactions (in a single transaction
category)
The proportion of incoming transactions out of all transactions (in a single transaction
category)
Minimum value in Ether ever received (where the receipt of Ether is for each account seen
during an analyzed time period)
Maximum value in Ether ever received
Average value in Ether ever received
Minimum value in Ether ever sent (where the sending of Ether is for each account seen
during an analyzed time period)
Maximum value in Ether ever sent
Average value in Ether ever sent
Total value in Ether ever received
Total value in Ether ever sent
The average number of transactions
The average number of incoming transactions
The average number of outcoming transactions
The average number of incoming transactions
The average outcoming amounts
The average incoming amounts
The total amounts of outcoming plus incoming transactions
The average incoming amounts
The average outcoming amounts
The average number of transactions
The average amounts transferred
The average amounts transferred
Reverted transaction numbers, which refer to any transactions that have been reverted such
as by cancellation or refusal
The proportion of normal transactions out of all transactions (where a normal transaction is
an executed transaction that is not a token transaction)
The proportion of normal incoming transactions out of all incoming transactions
The proportion of normal incoming transactions out of all transactions
The proportion of normal outcoming transactions out of all incoming transactions
The proportion of normal outcoming transactions out of all transactions
The proportion of internal transactions out of all transactions
The proportion of internal incoming transactions out of all incoming transactions
The proportion of internal incoming transactions out of all transactions
The proportion of internal outcoming transactions out of all incoming transactions
The proportion of internal outcoming transactions out of all transactions
The proportion of token transactions out of all transactions
The proportion of token incoming transactions out of all incoming transactions
The proportion of token incoming transactions out of all transactions
The proportion of token outcoming transactions out of all incoming transactions
The proportion of token outcoming transactions out of all transactions
The proportion of Ether transferred by normal transactions out of all
The proportion of Ether sent by normal transactions out of all sent Ether
The proportion of Ether sent by normal transactions out of all Ether transferred
The proportion of Ether received by normal transactions out of all sent Ether
The proportion of Ether received by normal transactions out of all Ether transferred
The proportion of Ether transferred by internal transactions out of all
The proportion of Ether sent by internal transactions out of all sent Ether
The proportion of Ether sent by internal transactions out of all Ether transferred
The proportion of Ether received by internal transactions out of all sent Ether
The proportion of Ether received by internal transactions out of all Ether transferred
The proportion of Ether transferred by token transactions out of all
The proportion of Ether sent by token transactions out of all sent Ether
The proportion of Ether sent by token transactions out of all Ether transferred
The proportion of Ether received by token transactions out of all sent Ether
The proportion of Ether received by token transactions out of all Ether transferred

Thus, in some embodiments, the feature is based on any one or more of: a number of occurrences of the event; a time of the event; an identity of a blockchain client (such as an account address) associated with the blockchain; a type of transaction associated with the event; an executed transaction associated with the event; a reverted transaction associated with the event; a price associated with the event (such as a price in terms of Ether); and a computational resource usage associated with the event (such as consumed gas). Thus, information about an event such as a transaction can be used to derive a value for a feature such as listed in Table 1. For example, a time of a set of events can be used to derive a temporal value such as an average time between events.

In some embodiments, the data comprises a value associated with a feature (such as a feature listed in Table 1) that is indicative of the behavior of the smart contract.

In some embodiments, the value may be a numerical value such as a temporal measurement such as derived from a time associated with an event or set of events. Thus, in some embodiments, the feature is based on a timing of a set of events comprising the event.

In some embodiments, the value may be a statistical measure derived from the behavior of the smart contract such as a total number of a given event, average number (including the mean, median and mode) of the given event, etc. Where the value is an average of the given event, determining the average may involve selecting a time interval and working out the average number of the events (e.g., transactions) that occur across a set of such time intervals.

In some embodiments, the value comprises a text or character string, code, etc. That is, in some cases, the value may not be numerical in nature such as in the case that the feature is static feature.

The data for each smart contract in the training dataset may comprise a set of values associated with a corresponding set of features (where the set of features may be indicative of the behavior of the smart contract in the training dataset). Similarly, the data associated with a smart contract to be classified (i.e., where the data is to be classified by the machine learning model) may also include a set of values associated with a corresponding set of features, which may be the same features upon which the machine learning model has been trained.

The SCMM 414 may extract the smart contracts of interest and the corresponding transactions directly from a blockchain and stores them in a storage. The SCMM 414 may enable continuous monitoring of new transactions added to the blockchain or targeted analysis of individual addresses.

The DAM 416 may provide annotation for the training data. As noted above, values corresponding to features characterizing the smart contract's code and transactions' behavior may be synchronized by the DPSM 406. A role of the DAM 416 may be to annotate such data with a corresponding benign or malicious label. In some cases, the annotated data may be stored in a storage.

The SSM 418 may perform an additional check by selecting some addresses within those that have been classified as benign by the SAFDM module 404. The selected addresses (with the corresponding data) may be further classified by the SFCM module 402 to enhance the overall performance. The selection of account addresses for verification can be random, policy-based or based on a round-robin procedure. By selecting some addresses for further classification by the SFCM module 402, which may provide a more granular classification than the SAFDM module 404, the accuracy of the SAFDM module 404 can be verified.

The CVM 420 may, if the extracted behavior is found to be anomalous, assess the confidence of the classification result. If the classification is found to be unreliable, then the CVM 420 may instruct the SAFRM 412 to adjust the time interval to include a different amount (e.g., more) data and extract any adjusted values corresponding to the features. This classification process may be repeated until either (i) the classification confidence is high enough to proceed to fine-grained classification by the SFCM module 402, or (ii) all available for this data's time intervals were exhausted and SCMM 414 is to be instructed to repeat extraction of data directly from the blockchain to obtain a new snapshot of the behavior.

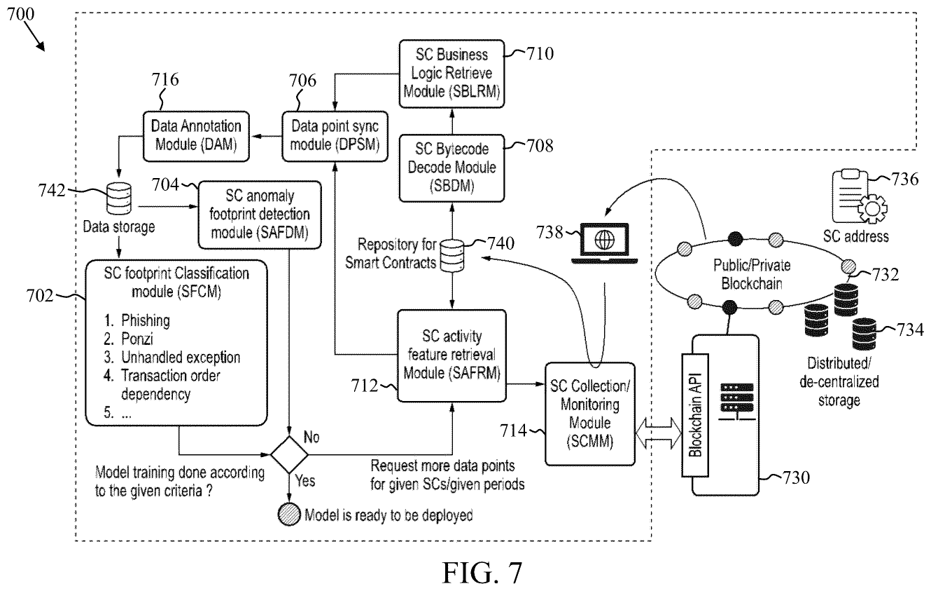

FIG. 7 is a schematic diagram illustrating a model training system 700 according to some embodiments. For example, the method 200 and related embodiments may implement at least part of such a model training system 700. Reference numerals for features in FIG. 7 that are similar to or correspond to features described in relation to FIG. 4 are incremented by 300. Further features and functionality of the model training system 700 are described below.

A blockchain Application Programming Interface (API) 730 may be used to access the blockchain 732 (which may be public or private) stored in distributed (e.g., de-centralized) storage 734 similar to the distributed computing system 102 of FIG. 1. A smart contract (SC) may have an associated SC address 736. For the prototype and evaluation using the Ethereum ecosystem, the blockchain 732 was accessed using the Ethereum API, the transactional history was extracted using the Etherscan API, smart contracts were extracted using geth, Go Ethereum API, and ether related information was extracted using the web3.eth API. Other APIs may be used to extract information from different types of blockchain ecosystems.

An example implementation of the model training system 700 is now described.

A blockchain client 738 (which may correspond to the blockchain client 110 of FIG. 1) may extract information from the blockchain 732 (e.g., to implement or facilitate the functionality of the SCMM 714) and store such information in a storage 740. Thus, the storage 740 may be a repository for smart contracts and their associated information (from which the values corresponding to features can be derived).

The SBDM 708 may extract certain information from the storage 740 to enable the SBDM 708 to disassemble a retrieved contract's bytecode to opcodes and operands, which are then transferred to the SBLRM 710.

The SAFRM 712 may extract certain information from the storage 740 to enable the SAFRM 712 to parse the retrieved information and extract temporal features from the corresponding events.

The DPSM 706 may synchronize the information (e.g., values) extracted by the SBDM 708 and the SAFRM 712, which is then transferred to the DAM 716 to annotate the data associated a smart contract's behavior. This annotated data is stored in a data storage 742. Although data storage 742 is depicted as a distinct entity with respect to the storage 740, in some cases, the data storage 742 may store the same information as stored by the storage 740.

The model training system 700 may rely on a set of smart contracts known to be abnormal or malicious. This set can be labeled manually or extracted from a third party (e.g., research labs).

The SAFDM module 704 may train the machine learning model (e.g., in accordance with the method 200 or the related embodiments) based on the annotated data associated with a training dataset of smart contracts stored in the data storage 742.

Similarly, the SFCM module 702 may train the machine learning model (e.g., in accordance with the method 200 or the related embodiments) based on the annotated data associated with the training dataset of smart contracts stored in the data storage 742. As depicted by FIG. 7, the sub-types of anomalous behavior may include phishing, Ponzi scheme, unhandled exception, transaction order dependency, etc. In this case, the DAM 716 may have also annotated the sub-type of behavior in the training dataset, so that the training can be performed to teach the machine learning model to classify the sub-type of behavior.

In some embodiments, the machine learning implemented by the SFCM module 702 and the SAFDM module 704 may further involve feature selection, as described in more detail below.

The trained machine learning model may be evaluated by analyzing the model with respect to set criteria (as described in more detail below). If the model meets the criteria, the model is ready to deployed. However, in the event that more data is needed or the timescale of the data needs to be changed because the criteria have not been satisfied, a corresponding request is made to the SAFRM 712. For example, if the classification result is not sufficiently accurate, i.e., misclassification rate is below a tolerable threshold, additional contract and transactional information may be requested. In some cases, the SAFRM 712 has access to such data that meets the request and this data is sent to the DPSM 706. However, in some cases, the requested data is not available, so the SAFRM 712 may interact with the SCMM 714 in order to facilitate extraction of more data from the blockchain 732.

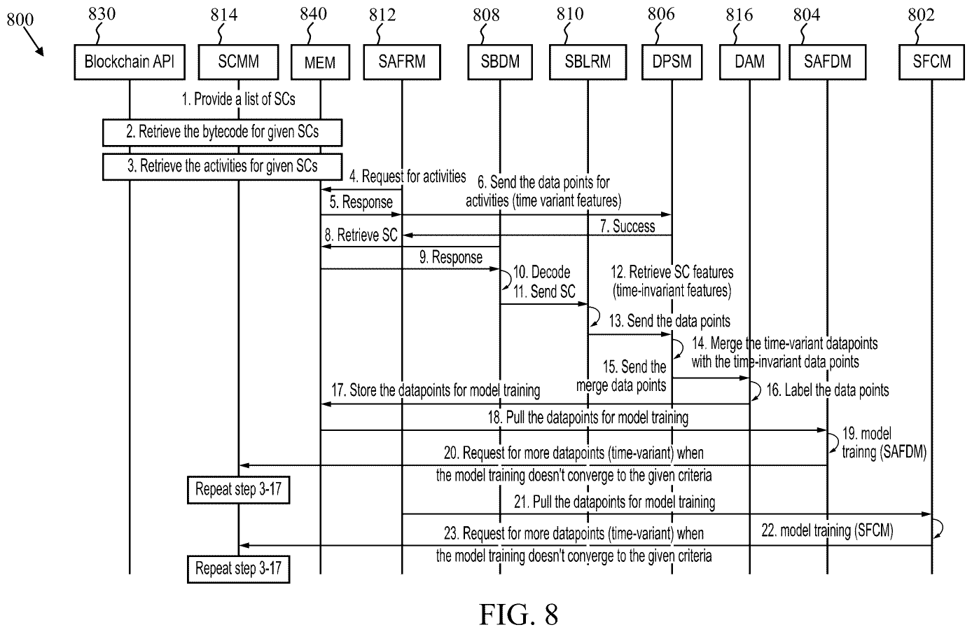

FIG. 8 is a flowchart of a method 800 of training a machine learning model according to some embodiments. The method 800 is described with reference to the modules and features of the model training system 700. Reference numerals for modules and features in FIG. 8 that are similar to or correspond to modules and features described in relation to FIG. 7 are incremented by 100. The method 200 may be implemented as part of the method 800. Similar to FIG. 2, method 800 is computer-implemented, for example, by a processor of a computing device. With reference to the description of FIG. 4, it is to be understood that the functionality of each module may be implemented by the same or a different processor, depending on the architecture of the model training system 700.

The steps of the method 800 are described below. In some cases, certain steps may be omitted or performed in a different order.
At step 1, the SCMM 814 provides a list of all smart contracts (SCs).
At step 2, the blockchain API 830 retrieves the bytecode for the given SCs and provides the bytecode to the mem 840 (i.e., memory/storage) via the SCMM 814.
At step 3, the blockchain API 830 retrieves the activities (e.g., information corresponding to an event or set of events associated with the given SC) for the given SCs to the mem 840 via the SCMM 814.
At step 4, the SAFRM 812 requests the activities associated with the smart contract from the mem 840.
At step 5, the mem 840 responds to the SAFRM 812 with the data points (e.g., values) associated with the requested activities.
At step 6, the SAFRM 812 sends the data points for the activities (i.e., dynamic features, which may be referred to as time variant features) to the DPSM 806.
At step 7, the DPSM 806 may indicate success to the SAFRM 812 if the DPSM 806 successfully receives the data points.
At step 8, the SBDM 808 seeks to retrieve an SC from the mem 840.
At step 9, the SBDM 808 receives a response from the mem 840 comprising information regarding the SC (i.e., static features, which may be referred to as time invariant features). Such information may comprise bytecode.
At step 10, the SBDM 808 decodes the information.
At step 11, the SBDM 808 sends the decoded information (e.g., opcodes and operands) to the SBLRM 810 for assembly of the features (and corresponding values) needed for training.
At step 12, the DPSM 806 retrieves the SC features (i.e., the time-invariant features). This can be done at step 13 by the SBLRM 810 sending the corresponding data points to the DPSM 806.
At step 14, the DPSM 806 merges the time variant data points with the time-invariant data points.
At step 15, the DPSM 806 sends the merged data points to the DAM 816.
At step 16, the DAM 816 labels the data points.
At step 17, the DAM 816 instructs the data mem 840 to store the labeled data points. FIG. 7 depicted separate storage 740, 742. For ease of understanding, the data mem 840 may store the same data as described in relation to the storage 740, 742 of FIG. 7.
At step 18, the SAFDM module 804 pulls the labeled data points from the mem 840.
At step 19, the SAFDM module 804 trains the machine learning model based on these labeled data points.
At step 20, the SAFDM module 804 may (if necessary) request more data points (e.g., time variant features) from the SCMM 814 if the model training does not converge to given criteria. In response to such a request, the SCMM 814 may repeat steps 3 to 17.
At step 21, the SFCM module 802 pulls the labeled data points from the mem 840 (where the labels include the sub-type of behavior).
At step 22, the SFCM module 802 trains the machine learning model based on these labeled data points.
At step 23, the SFCM module 802 may (if necessary) request more data points (e.g., time variant features) from the SCMM 814 if the model training does not converge to given criteria. In response to such a request, the SCMM 814 may repeat steps 3 to 17.

Thus, the retrieved features may be used to train a classification (machine learning) model to identify anomalous behavior, i.e., a binary classification of normal and anomalous behavior (via the SAFDM module 804). In some embodiments, a particular type of anomalous behavior may be classified by the model, i.e., muti-class classification (via the SFCM module 802). In some embodiments, the SAFDM module 804 and the SFCM module 802 may also be responsible for feature selection (e.g., in the case that some features are more important than others for the purpose of classifying the data points).

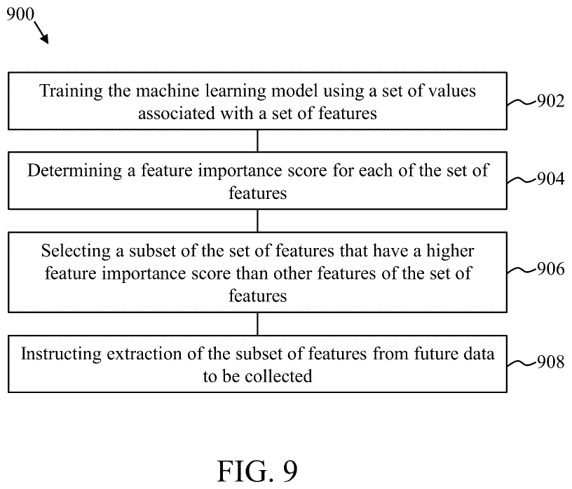

FIG. 9 is a flowchart of a method 900 of selecting features to collect from future data according to some embodiments. The method 900 may be implemented by the same entity as described in relation to the method 200 and related embodiments. For example, the SFCM module 802 or the SAFDM module 804 may implement the method 900.

There may be scenario where multiple features are extracted and some of these features are more relevant than other features to the classifying process implemented by the machine learning model. The method 900 may facilitate feature selection to improve the efficiency of the learning process or the classification process when the machine learning model is deployed (e.g., there may be less demand on compute resources if fewer features are selected for training or classifying).

The data associated with the smart contract comprises a set of features with an associated set of values derived from a set of events associated with execution of the smart contract.

The method 900 comprises, at step 902, training the machine learning model using the set of values.

The method 900 further comprises, at step 904, determining a feature importance score for each of the set of features. The feature importance score is indicative of how useful the feature is for predicting the type of behavior. For example, the process of training of the machine learning model may yield the feature importance score for each feature such that it may be possible to determine which features are more useful than others for predicting behavior of the smart contract. Some features may not be particularly useful for prediction so they need not be collected in the future.

Thus, the method 900 further comprises, at step 906, selecting a subset of the set of features that have a higher feature importance score than other features of the set of features. The selection may be based on certain criteria such as the feature having a feature importance score that exceeds a threshold importance score or the features may be ranked in terms of their respective feature importance score and a certain number or proportion from the top of the ranked features may be selected for the subset.

The method 900 further comprises, at step 908, instructing extraction of the subset of features from future data collected that is representative of behavior of a smart contract to be classified by the machine learning model. For example, any of the relevant modules that retrieves or extracts relevant features from the subset may be instructed to only retrieve or extract such features in the future to reduce usage of compute resource (e.g., in terms of storing data, retrieving data, training based on the data or classifying based on the data).

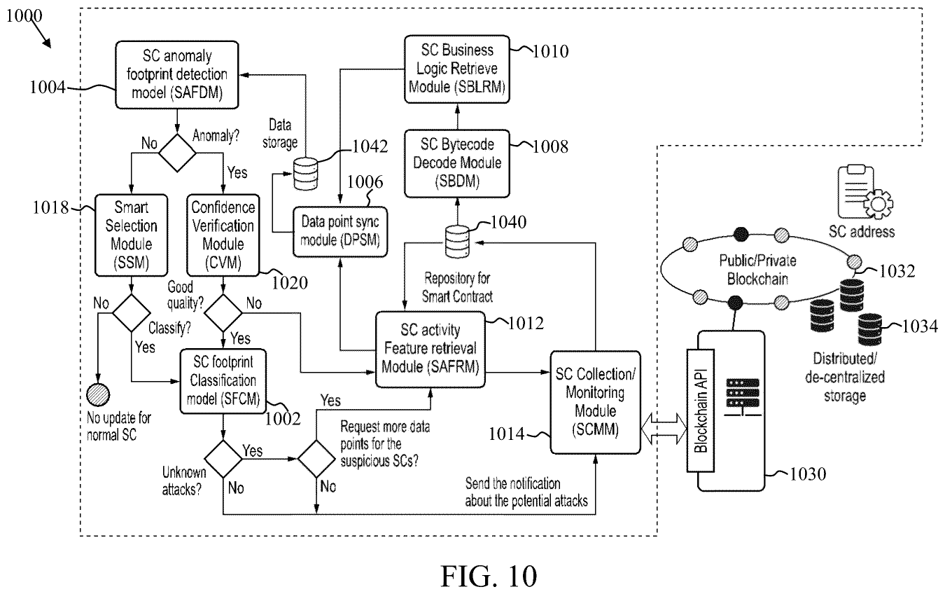

FIG. 10 is a schematic diagram illustrating a system 1000 to implement a deployed machine learning model according to some embodiments.

For example, the method 300 and related embodiments may implement at least part of such a system 1000. Reference numerals for features in FIG. 10 that are similar to or correspond to features described in relation to FIG. 4 are incremented by 600. Certain features and functionality described in relation to the model training system 700 of FIG. 7 may also be implemented by the system 1000, in which case a further description of this functionality is not provided below for brevity. Further features and functionality of the system 1000 are described below.

An example implementation of the system 1000 is now described.

Similar to FIG. 7, the system 1000 comprises a blockchain API 1030, blockchain 1032, storage 1034, SCMM 1014, mem 1040, SBDM 1008, SBLRM 1010, SAFRM 1012, DPSM 1006, data storage 1042, SAFDM module 1004 and SFCM module 1002. Each of these modules may implement similar functionality to the corresponding modules described in FIG. 7. However, some functionality is different and further modules are implemented as part of the system 1000, as described below.

In use, the SAFDM module 1004 classifies the behavior of a smart contract based on the data stored in the data storage 1042 (noting that the DAM 716 is not used in the system 1000). The classification may indicate that the behavior is normal or anomalous.

If the smart contract's behavior is classified as anomalous, the CVM 1020 assesses the confidence of the classification result, as provided in certain embodiments described herein.

If the confidence is good (i.e., the classification is a good quality) then, in some embodiments, the SFCM module 1002 performs multi-classification to determine the sub-type of the behavior.

If the sub-type of the behavior is known, the SCMM 1014 is informed about the smart contract's anomalous behavior so that the SCMM 1014 may take appropriate action such as informing an admin or monitoring the smart contract's future behavior.

If the sub-type of the behavior is unknown, a decision may be made to request more data for the suspicious smart contract from the SAFRM 1012 (e.g., if such data is available). Otherwise, the SCMM 1014 may be informed about the smart contract's anomalous behavior so that the SCMM 1014 may take appropriate action such as informing an admin or monitoring the smart contract's future behavior.

If the confidence outcome is not good (i.e., the classification is not good quality) then the CVM 1020 may instruct the SAFRM 1012 to provide more data about the smart contract. In some embodiments, this may involve the SAFRM 1012 requesting such data from the SCMM 1014.

In the case that the SAFDM module 1004 indicates that the smart contract's behavior is normal, the SSM 1018 may decide whether to select the smart contract for more fine-grained classification by the SFCM module 1002, as described above. Thus, if the smart contract is not selected, there is no update for any other module (or no further action is taken even if another module is updated that the smart contract's behavior is normal). However, if the smart contract is selected, the SFCM module 1002 is instructed to classify the smart contract's behavior, as described above.

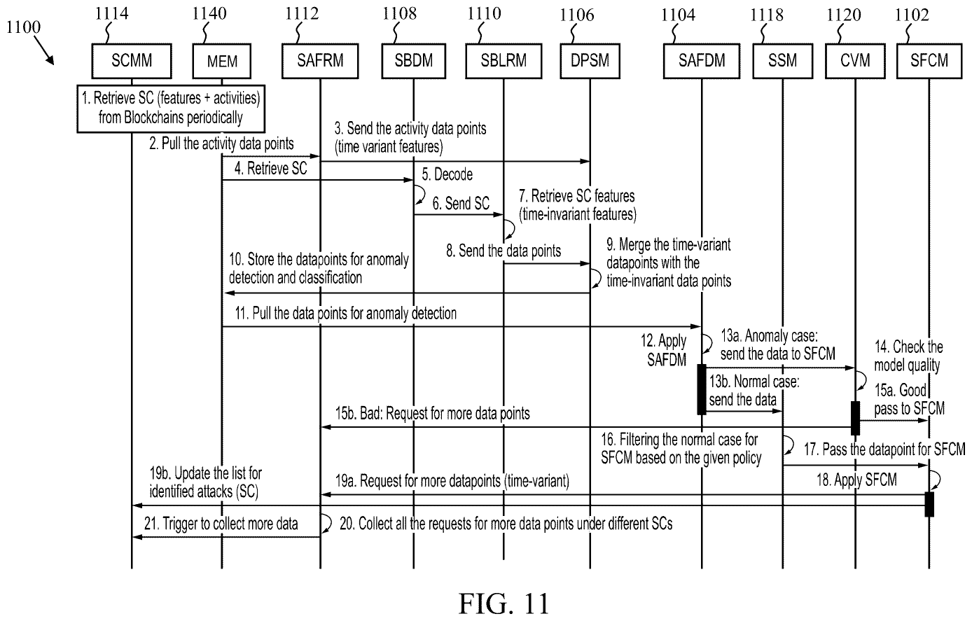

FIG. 11 is a flowchart of a method 1100 of classifying a type of behavior with a machine learning model according to some embodiments.

The method 1100 is described with reference to the modules and features of the system 1000. Reference numerals for modules and features in FIG. 11 that are similar to or correspond to modules and features described in relation to FIG. 10 are incremented by 100. The method 300 may be implemented as part of the method 1100. Similar to FIG. 3, method 1100 is computer-implemented, for example, by a processor of a computing device. With reference to the description of FIG. 4, it is to be understood that the functionality of each module may be implemented by the same or a different processor, depending on the architecture of the system 1100.

The steps of the method 1100 are described below. In some cases, certain steps may be omitted or performed in a different order.
At step 1, the SCMM 1114 periodically retrieves information corresponding to a smart contract's features and activities from the blockchain, and stores this information in the mem 1140.
At step 2, the SAFRM 1112 pulls the smart contract activity data points from mem 1140.
At step 3, the SAFRM 1112 sends the (time variant) data points (e.g., values corresponding to temporal features) to the DPSM 1106.
At step 4, the SBDM 1108 retrieves the smart contract from the mem 1140.
At step 5, the SBDM 1108 decodes the smart contract.
At step 6, the SBDM 1108 sends the decoded smart contract to the SBLRM 1110.
At step 7, the SBLRM 1110 retrieves the time invariant features of the smart contract.
At step 8, the SBLRM 1110 sends the data corresponding to the time invariant features (e.g., the values corresponding to opcodes and operands) to the DPSM 1106.
At step 9, the DPSM 1106 merges the time variant data points with the time invariant data points.
At step 10, the DPSM 1106 instructs the mem 1140 to store the merged data points for anomaly detection and classification.
At step 11, the SAFDM module 1104 pulls the data points provided in step 10.
At step 12, the SAFDM module 1104 performs classification.
At step 13a, the SAFDM module 1104 sends the data to the CVM 1120 in the case that the classification indicates that the smart contract's behavior is anomalous.
At step 14, the CVM 1120 checks the quality of the model's classification prediction.
At step 15a, the CVM 1120 passes the data to the SFCM module 1102 if the quality of the classification is good.
At step 15b, the CVM 1120 sends a request for more data points to the SAFRM 1112 if the quality of the classification is bad (whereupon steps 2 to 15 may be repeated until the classification is good).
At step 13b, the SAFDM module 1104 sends the data to the SSM 1118 in the case that the classification indicates that the smart contract's behavior is normal.
At step 16, the SSM 1118 filters the smart contracts that have been classified as normal to select the smart contract based on a given policy (e.g., random, policy-based or based on a round-robin procedure, as described above).
At step 17, the SSM 1118 passes the data points for the selected smart contract to the SFCM module 1102.
At step 18, the SFCM module 1102 performs fine-grained classification on the data it has received (e.g., at step 15a or step 17).
At step 19a, the SFCM module 1102 instructs the SAFRM 1112 to provide more time-variant features (e.g., by repeating at least some of steps 2 to 17), for example, if the classification does not meet certain criteria such as an accuracy level.
At step 19b, the SFCM module 1102 instructs the SCMM 1114 to update a list of identified anomalous behavior of the classified smart contract.
At step 20, the SAFRM 1112 collects all the requests for more data points under different smart contracts.
At step 21, a request at step 20 triggers the SAFRM 1112 to collect or instruct collection of more data by the SCMM 1114.

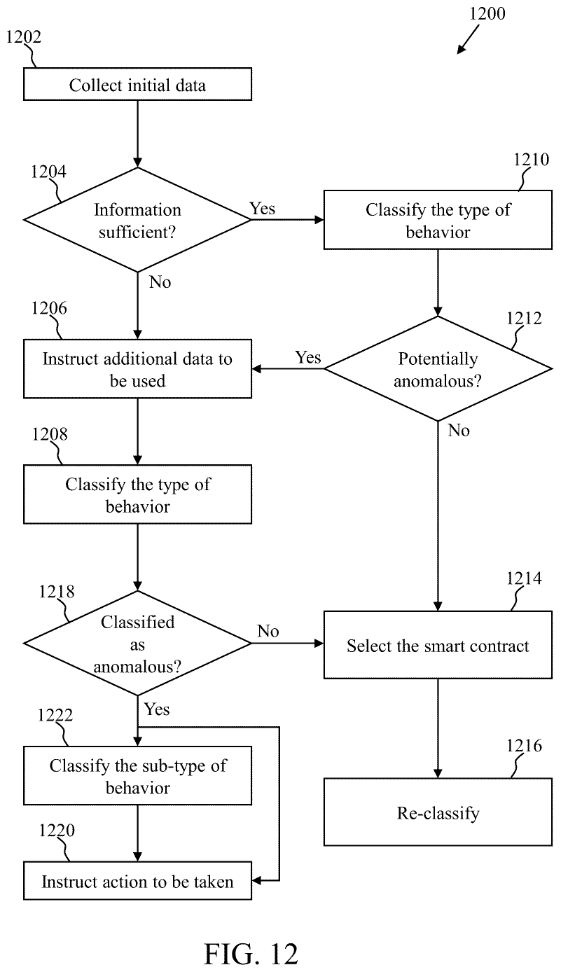

FIG. 12 is a flowchart of a method 1200 of classifying a type of behavior with a machine learning model according to some embodiments. The method 1200 may implement certain steps described in relation to FIGS. 10 and 11. Thus, certain steps of the method 1200 may be performed by the appropriate module described in relation to FIGS. 10 and 11. Certain steps of the method 1200 may be omitted or implemented in a different order to that depicted by FIG. 12.

The steps of the method 1200 are described below.

In some embodiments, step 1202 comprises collecting initial data associated with the smart contract (such as the values for the time variant and the time invariant features).

In some embodiments, step 1204 determines whether the information is sufficient for classification.

If the information is insufficient, the method 1200 proceeds to step 1206.

If the information is sufficient, the behavior of the smart contract is classified at step 1210. If the smart contract is classified as potentially anomalous at step 1212, the method 1200 may proceed to step 1206. If not anomalous, the method 1200 may proceed to step 1214.

In some embodiments, in response to an insufficient level of information being available in initially-collected data for a specified accuracy of classification of the type of behavior of the smart contract, step 1206 instructs additional data to be used for classifying the type of behavior of the smart contract. The additional data comprises data collected over a longer time interval than the initially-collected data. At step 1208, the method 1200 comprises classifying the type of behavior of the smart contract with the machine learning model. The classifying is performed by the machine learning model using the additional data. Thus, if data in the initially collected data is insufficient for good quality classification, more data (covering a longer time interval) may be collected in order to achieve a specified accuracy. For example, the SAFDM module 1104 may be instructed to perform classification based on the additional data if the initial classification performed by the SAFDM module 1104 based on the initially collected data is insufficient for accurate classification.

In some embodiments, in response to the type of behavior being classified as potentially anomalous based on initially-collected data, at step 1206, the method 1200 comprises instructing additional data to be used for classifying the type of behavior of the smart contract. The additional data comprises data collected over a longer time interval than the initially-collected data. At step 1208, the method 1200 comprises classifying the type of behavior of the smart contract with the machine learning model to determine whether or not the smart contract is anomalous. The classifying is performed by the machine learning model using the additional data. For example, the SAFDM module 1104 may be instructed to adjust the time interval over which the data for classification is obtained, to monitor an abnormal smart contract if, for example, it is not clear if the smart contract is abnormal or not.

In some embodiments, in response to the type of behavior of the smart contract being classified as benign (i.e., “no” at step 1218), at step 1214, the method 1200 comprises selecting the smart contract (e.g., based on a policy such as described above). At step 1216, the method 1200 comprises classifying (i.e., re-classifying) the data associated with selected smart contract using the machine learning model. The machine learning model is further trained to identify a sub-type of the behavior from the data. Thus, the classifying at step 1216 may be performed by the SFCM module 1102.

In some embodiments, in response to the type of behavior of the smart contract being classified as anomalous at step 1218 (i.e., “yes”), at step 1220, the method 1200 comprises instructing an action to be taken by a node configured to monitor the blockchain to obtain future data for use in classifying the type of behavior of the smart contract. The action comprises monitoring future activity of a blockchain client identified as being configured to execute the smart contract classified as anomalous.

In some embodiments, in response to the classifying of the type of behavior achieving a specified confidence level (i.e., “yes” at step 1218), at step 1222, the method 1200 comprises classifying a sub-type of the behavior of the smart contract with the machine learning model. The machine learning model is trained to identify the sub-type of behavior from the data. The sub-type of the behavior is a sub-type of anomalous behavior. The identified sub-type of the behavior may be provided to instruct action to be taken at step 1220. The sub-type may be: phishing, Ponzi, crypto theft, honeypot, high risk, etc.

The following section describes the experimental system training and evaluation of the trained machine learning model for classifying smart contract behavior.

The modules described herein were implemented using the Python language (v.3.8.4) with the scikit-learn library (v.0.23.1). For hyperparameter optimization, the grid search approach was used. 4-fold cross-validation was employed to measure the accuracy of the machine learning model.

For the evaluation, a dataset (Table 2) was collected representing several sub-types of threats: phishing attacks, Ponzi scheme contracts, honeypot contracts, i.e., contracts deliberately designed to entice attackers to exploit the existing flaws, high risk contracts that include various vulnerabilities such as reentrancy bug, unchecked low-level calls, etc. A number of non-malicious (normal) smart contracts were part of the dataset. Table 2 also indicates the number of samples associated with each type of behavior.

The training dataset included the transaction history of each address involved in the above mentioned threats. All corresponding information and transactions were extracted using the Ethereum API. The dataset used for evaluation was labeled with the corresponding threat information. The features and corresponding values, as described above, were derived from the dataset.

TABLE 2

| Category | Samples |
|---|---|
| Phishing | 5186 |
| Ponzi | 298 |
| Coin stolen | 826 |
| Honeypot | 1162 |
| High risk | 2472 |
| Non-malicious | 5320 |
| TOTAL | 15264 |

The results obtained by use of the trained machine learning model are now described.

The experiments can be divided into two parts: non time-based (i.e., static) and time-based (temporal) analysis. For non-time based experiments, only code related features and features in Table 1 are taken into consideration. In other words, all transactions available on the chain are used in these experiments.

For time-based experiments, various time windows were created from which the features (and the corresponding values) listed in Table 1 were generated for each of the time windows.

For the non-time based experiments, the result of the classification is presented in Tables 3 and 4, which show the high accuracy of differentiating benign and malicious behavior, and various categories of threats. This result may be expected as all available on the chain information is leveraged for this classification.

TABLE 3
Binary classification (non-time based experiments) results based on the XGBOOST and LIGHTGBM models:

| | XGBOOST | | | LIGHTGBM | | |
|---|---|---|---|---|---|---|
| Category | Precision | Recall | F1-Score | Precision | Recall | F1-Score |
| Non-Malicious | 0.945 ± 0.005 | 0.95 ± 0.01 | 0.95 ± 0.0 | 0.945 ± 0.005 | 0.95 ± 0.01 | 0.95 ± 0.0 |
| Malicious | 0.91 ± 0.2 | 0.90 ± 0.0 | 0.905 ± 0.005 | 0.905 ± 0.015 | 0.90 ± 0.01 | 0.905 ± 0.005 |
| Accuracy: | | | 0.93 ± 0.01 | | | 0.93 ± 0.01 |
| Macro Avg | 0.925 ± 0.005 | 0.925 ± 0.005 | 0.925 ± 0.005 | 0.925 ± 0.005 | 0.925 ± 0.005 | 0.925 ± 0.005 |
| Weighted Avg | 0.935 ± 0.005 | 0.935 ± 0.005 | 0.935 ± 0.005 | 0.935 ± 0.005 | 0.935 ± 0.005 | 0.935 ± 0.005 |

TABLE 4
Multi-class classification (non-time based experiments)
results based on the XGBOOST and LIGHTGBM models:

| | XGBOOST | | | LIGHTGBM | | |
|---|---|---|---|---|---|---|
| Category | Precision | Recall | F1-Score | Precision | Recall | F1-Score |
| Phishing | 0.935 ± 0.005 | 0.895 ± 0.005 | 0.915 ± 0.005 | 0.935 ± 0.005 | 0.895 ± 0.005 | 0.915 ± 0.005 |
| Ponzi | 0.775 ± 0.035 | 0.525 ± 0.055 | 0.925 ± 0.025 | 0.735 ± 0.065 | 0.48 ± 0.03 | 0.58 ± 0.03 |
| Coin Stolen | 0.99 ± 0.01 | 0.955 ± 0.015 | 0.97 ± 0.01 | 0.975 ± 0.015 | 0.96 ± 0.02 | 0.97 ± 0.01 |
| Non-Malicious | 0.92 ± 0.0 | 0.91 ± 0.005 | 0.91 ± 0.005 | 0.915 ± 0.05 | 0.92 ± 0.01 | 0.915 ± 0.005 |
| Honeypot | 0.895 ± 0.015 | 0.755 ± 0.025 | 0.82 ± 0.01 | 0.89 ± 0.02 | 0.765 ± 0.015 | 0.825 ± 0.005 |
| High Risk | 0.795 ± 0.005 | 0.965 ± 0.005 | 0.87 ± 0.01 | 0.795 ± 0.005 | 0.955 ± 0.015 | 0.875 ± 0.005 |
| Accuracy | | | 0.90 ± 0.0 | | | 0.895 ± 0.005 |
| Macro Avg | 0.895 ± 0.005 | 0.835 ± 0.005 | 0.855 ± 0.005 | 0.88 ± 0.01 | 0.83 ± 0.01 | 0.845 ± 0.005 |
| Weighted Avg | 0.90 ± 0.0 | 0.90 ± 0.0 | 0.90 ± 0.0 | 0.90 ± 0.01 | 0.895 ± 0.005 | 0.895 ± 0.005 |

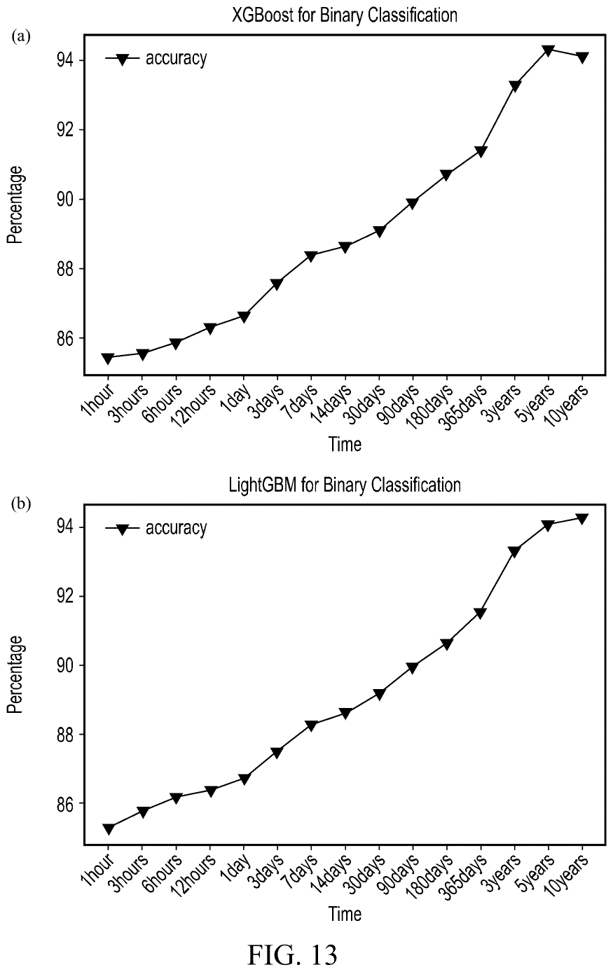

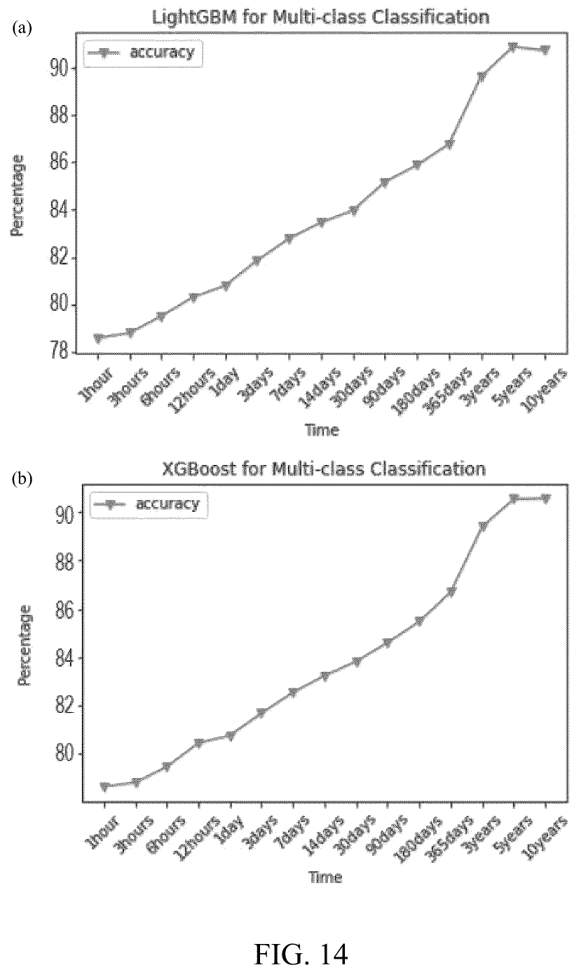

For the time based experiments, the results of time-based classification analysis are depicted by FIGS. 13 and 14.

FIGS. 13(a)-(b) are graphs of experimental data indicating binary classification accuracy for a set of time windows.

FIGS. 14(a)-(b) are graphs of experimental data indicating multi-class classification accuracy for a set of time windows.

For these experiments, a model was trained based on the data available for each time window and the accuracy was tested using a cross-validation approach.

As the results show, the classification accuracy for binary classification quickly increases, starting at 85% (XGBoost and LightGBM) for a time window of 1 hour of data and peaking at 94% for a time window of 5-10 years of data.

As the results show, the classification accuracy for multi-class classification quickly increases starting at around 79% (LightGBM and XGBoost) for a time window of 1 hour and peaking at 91% for a time window of 5-10 years of data.

As expected, the accuracy of binary classification is a slightly higher than multi-class classification as multi-class classification is generally a more challenging task.

The results highlight an advantage of temporal analysis, i.e., it is possible to detect anomalous behavior within 1 hour after transaction deployment, which is a significant improvement compared to the traditional approaches based on all available data.

The results also emphasize the benefits of the proposed approach that seeks additional data if unconclusive detection is obtained, i.e., as time goes by more data can be extracted by broadening a time window. This approach may provide a more accurate detection. Hence, the proposed systems according to certain embodiments described herein may allow for a significant flexibility in the mitigation response, i.e., in a setting when more critical threats are suspected, the system can fire an immediate response, while for more tolerable cases, the system can afford to collect and process additional data until more accurate detection is achieved.

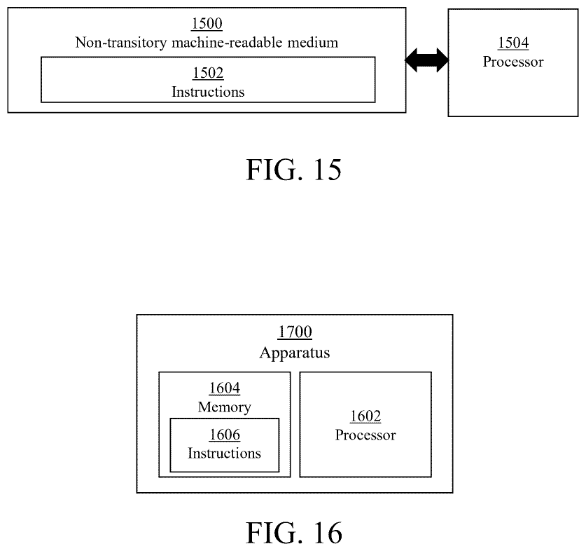

FIG. 15 is a schematic diagram of a machine-readable medium 1500 for implementing some embodiments. The machine-readable medium 1500 is a non-transitory machine-readable medium 1500 storing instructions 1502 which, when executed by a processor 1504, instruct the processor 1504 to implement a method according any of the embodiments described herein such as the method 200, 300, 800, 900, 1100, 1200 or the related embodiments. The non-transitory machine-readable medium 1500 may be implemented by any appropriate module of the modules described in relation to FIGS. 4, 7 and 10.

FIG. 16 is a schematic diagram of an apparatus 1600 for implementing some embodiments. The apparatus 1600 comprises a processor 1602. The apparatus 1600 further comprises a memory 1604 storing instructions 1606 readable and executable by the processor 1602 to instruct the processor 1604 to implement a method according any of the embodiments described herein such as the method 200, 300, 800, 900, 1100, 1200 or the related embodiments. The apparatus 1600 may be implemented by any appropriate module of the modules described in relation to FIGS. 4, 7 and 10.

Any element or functionality of a described embodiment may be combined with or replace a corresponding element or functionality of another described embodiment.

In some embodiments, a carrier comprising the aforementioned computer program product is provided. The carrier is one of an electronic signal, an optical signal, a radio signal, or a computer readable storage medium (e.g., a non-transitory computer readable medium such as memory).

Some embodiments may be represented as a non-transitory software product stored in a machine-readable medium (also referred to as a computer-readable medium, a processor-readable medium, or a computer usable medium having a computer readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), flash storage, or similar storage mechanism. The machine-readable medium may contain various sets of instructions, code sequences, configuration information, or other data, which, when executed, cause a processor to perform steps in a method according to one or more of the described embodiments. Those of ordinary skill in the art will appreciate that other instructions and operations necessary to implement the described embodiments may also be stored on the machine-readable medium. Software running from the machine-readable medium may interface with circuitry to perform the described tasks.

A processor (which includes one or more processors) may include a central processing unit (CPU), application specific integrated circuit (ASIC), field programmable gate array (FPGA) or the like.

The above-described embodiments are intended to be examples only. Alterations, modifications and variations may be effected to the particular embodiments by those of skill in the art without departing from the scope of the description, which is defined solely by the appended claims.

1. A computer-implemented method, comprising:
receiving data representative of an event that occurs as a result of execution of a smart contract deployed on a blockchain; and
classifying a type of behavior of the smart contract with a machine learning model trained to identify the type of behavior from the data.

2. The method of claim 1, wherein the machine learning model is trained using a dataset comprising data representative of behavior of a training set of smart contracts, wherein the data associated with a smart contract of the training set is annotated in the dataset with the type of behavior exhibited by the smart contract.

3. The method of claim 1, wherein the type of behavior comprises: benign or anomalous.

4. The method of claim 1, wherein the event comprises execution of instruction code for controlling an operation of a processor of a blockchain node configured to execute the smart contract, wherein the smart contract is compiled into the instruction code.

5. The method of claim 4, wherein the instruction code comprises bytecode.

6. The method of claim 4, wherein instruction code comprises opcode and operands.

7. The method of claim 6, wherein the data comprises an indication of a weighted measure of the opcode frequency in the smart contract relative to a set of smart contracts.

8. The method of claim 4, wherein the data comprises content of the instruction code.

9. The method of claim 1, wherein the data comprises a value associated with a feature that is indicative of the behavior of the smart contract.

10. The method of claim 9, wherein the feature is based on any one or more of:
a number of occurrences of the event;
a time of the event;
an identity of a blockchain client associated with the blockchain;
a type of transaction associated with the event;
an executed transaction associated with the event;
a reverted transaction associated with the event;
a price associated with the event; and
a computational resource usage associated with the event.

11. The method of claim 9, wherein the feature is based on a timing of a set of events comprising the event.

12. The method of claim 1, further comprising:
in response to an insufficient level of information being available in initially-collected data for a specified accuracy of classification of the type of behavior of the smart contract, instructing additional data to be used for classifying the type of behavior of the smart contract, wherein the additional data comprises data collected over a longer time interval than the initially-collected data; and
classifying the type of behavior of the smart contract with the machine learning model, wherein the classifying is performed by the machine learning model using the additional data.

13. The method of claim 1, further comprising:
in response to the type of behavior being classified as potentially anomalous based on initially-collected data, instructing additional data to be used for classifying the type of behavior of the smart contract, wherein the additional data comprises data collected over a longer time interval than the initially-collected data; and
classifying the type of behavior of the smart contract with the machine learning model to determine whether or not the smart contract is anomalous, wherein the classifying is performed by the machine learning model using the additional data.

14. The method of claim 1, further comprising:
in response to the type of behavior of the smart contract being classified as benign, selecting the smart contract; and
classifying the data associated with selected smart contract using the machine learning model, wherein the machine learning model is further trained to identify a sub-type of the behavior from the data.

15. The method of claim 1, further comprising:
in response to the type of behavior of the smart contract being classified as anomalous, instructing an action to be taken by a node configured to monitor the blockchain to obtain future data for use in classifying the type of behavior of the smart contract, wherein the action comprises monitoring future activity of a blockchain client identified as being configured to execute the smart contract classified as anomalous.

16. The method of claim 1, further comprising:
in response to the classifying of the type of behavior achieving a specified confidence level, classifying a sub-type of the behavior of the smart contract with the machine learning model, wherein the machine learning model is trained to identify the sub-type of behavior from the data, and wherein the sub-type of the behavior is a sub-type of anomalous behavior.

17. A computer-implemented method, comprising:
training a machine learning model to classify a type of behavior of a smart contract deployed on a blockchain, wherein the training is performed using a dataset comprising data representative of behavior of a training set of smart contracts, wherein the data associated with a smart contract of the training set is annotated in the dataset with the type of behavior exhibited by the smart contract.

18. The method of claim 17, wherein the data associated with the smart contract comprises a set of features with associated values derived from a set of events associated with execution of the smart contract, the method further comprising:
training the machine learning model using the set of values;
determining a feature importance score for each of the set of features, wherein the feature importance score is indicative of how useful the feature is for predicting the type of behavior;
selecting a subset of the set of features that have a higher feature importance score than other features of the set of features; and
instructing extraction of the subset of features from future data collected that is representative of behavior of a smart contract to be classified by the machine learning model.

19. A non-transitory machine-readable medium storing instructions which, when executed by a processor, instruct the processor to implement the method of claim 1.

20. An apparatus comprising:
a processor; and
a memory storing instructions readable and executable by the processor to instruct the processor to:
receive data representative of an event that occurs as a result of execution of a smart contract deployed on a blockchain; and
classify a type of behavior of the smart contract with a machine learning model trained to identify the type of behavior from the data.
